(19) United States
(12) Patent Application Publication
(10) Pub. No.: US 2012/0047059 A1
(43) Pub. Date: Feb. 23, 2012

(54) METHOD, SYSTEM, MARKET ENVIROMENT, COMPUTER PROGRAM PRODUCT AND FINANCIAL PRODUCT FOR ISSUING AND SELLING A PRIMARY SECURITY ON A SECONDARY MARKET

(75) Inventor: Michael VASINKEVICH, New York, NY (US)

(73) Assignee: Michael VasinKevich, New York, NY (US)

(21) Appl. No.: 12/861,491

(22) Filed: Aug. 23, 2010

(51) Int. Cl. G06Q 40/00; G06Q 90/00

(52) U.S. Cl. 705/37; 705/500

(57) ABSTRACT

A method, system and/or computer program product for selling a primary security into a public market on which a corresponding secondary security is concurrently offered for sale at a secondary market price that includes determining the secondary market price of the secondary security; offering the primary security for sale at a primary market price that is the same as the secondary market price; selling the primary security to a buyer at the primary market price; such that the primary security is offered for sale and sold by a seller and/or on behalf of the seller, and the seller is the issuer of the primary security; the primary security is a registered shelf offering; and during the selling, the primary security is indistinguishable from the secondary security to the buyer.

### BACKGROUND OF THE INVENTION

1. Field of the Invention

The invention relates to a system, method, market environment, computer program product and financial product for primary issuers selling primary securities into a secondary market. The invention includes a market environment that permits a primary issuer to sell primary (new) issues of securities without the services of a conventional underwriter or placement agent. The invention includes a primary issuer selling new shares of stock selectively onto an exchange supporting a secondary market to obtain the actual market price for the sale of the securities in the primary issue.

2. Description of the Related Art

Companies, corporations, bank holding companies, investment companies, unit investment trusts and other financial institutions raise capital for general investment and operating purposes by selling securities in the form of shares of equity, debt, option, warrants and rights etc. When in the form of shares of equity (stock) the securities entitle the holders of such securities to a fractional ownership interest in the entity that issued the securities. Alternately, or in addition, the securities entitle the owners to future financial benefits which may take the form of, for example, cash payments.

The first sale of a company's securities on a public exchange is known as a primary issue. An initial public offering (IPO) is the initial public sale of shares of equity in an entity such as a corporation that, prior to the IPO, was privately held or owned by another entity. An IPO allows the owners of a business to exchange their ownership interests for cash. Primary issues include not only IPOs but also the sale of any new shares of equity issued subsequent to an IPO.

The Securities Exchange Commission (SEC) of the U.S. Government and similar governmental regulatory agencies in foreign countries regulate IPOs to ensure that the public maintains confidence in the financial system. The requirements for issuing shares of stock and/or other securities through an IPO are especially stringent and impose limits on the actions of the owners of the business who are is selling, for example, shares of equity in an IPO.

When a publicly traded company issues securities in the form of shares of equity the securities are most often sold on an exchange such as a national exchange (e.g., NYSE, NASDAQ, ASE) which may be located in the United States or in a foreign country (e.g., ISE, Euronext, OMX, LSE). Such exchanges provide a secondary market on which securities such as shares of equity are bought and sold between parties unrelated to the original issuer.

After a first sale (i.e., the primary sale from the primary issuer to another party) of a security any subsequent sale of the security is a secondary sale. The original issue of the securities benefits directly from the sale of securities in the form of cash income only from the primary sale, e.g., from an IPO. Any appreciation in the value of the security subsequent to the primary sale belongs to the individual and/or investor who purchased the security after its primary issue.

In order to carry out a successful sale of securities the owners of the underlying business must effectively market the primary securities to the public and/or to investors. The sale and marketing of newly issued securities such as shares of equity is an area of expertise that is far outside the knowledge and experience of most business owners and/or their employees. Business owners commonly engage underwriters to market IPOs and/or the sale of other types of securities. Underwriters have access to a network of investors who are willing to exchange cash for securities. The underwriters also have an in-house knowledge base to price new securities and to comply with applicable regulations. Underwriters provide an important service to primary issuers by guaranteeing that all of the primary securities offered for sale will actually be sold and/or the primary issuer will received value for all securities offered for sale. If the underwriter is unable to find sufficient investors to purchase all of the securities, the underwriter may be liable for making up any shortfall in sales. Although it is not a requirement to use an underwriter to sell securities, in most instances it is the only practical way of carrying out the sale of newly issued securities.

Underwriters obtain a fee that is commensurate with the services provided in the sale of securities. For an IPO of newly issued shares of equity in a relatively small or newly formed company, an underwriter may receive as much as 8% of the proceeds from the sale of the securities as payment for the underwriter's services. The company undertaking the sale of securities would of course prefer not to pay this fee. However, to successfully complete a sale of securities, companies issuing new securities have little choice but to pay the underwriter's fee.

Under certain circumstances the sale of newly issued securities subsequent to an IPO (e.g., a follow-on sale of new securities) may be subject to less stringent regulatory and reporting requirements than the IPO. These later sales are still primary sales because the securities are being offered for sale for the first time. The securities are thus characterized as a primary issue (e.g., known as a follow-on offering or secondary offering; aka a second primary issue) but an not an IPO. Nonetheless, in most cases an underwriter is still involved in any primary security sales subsequent to an IPO. While the underwriter's fee and/or commission may be lower for subsequent primary issues and/or follow-on issues than for IPOs, fees ranging from 2-5% of the total sales are common.

The issuer/company carrying out a second primary issue is subject to several important disadvantages. First, the issuer is burdened with the underwriter's fee and is thus unable to efficiently and fully capitalize on its goodwill and reputation. Second, the timing and frequency of the primary sales may be dictated by the underwriter thereby prohibiting the company from taking full advantage of market conditions when planning and/or executing sales.

The present invention provides a method, system, market environment, computer program product and financial product for issuing and/or selling primary issues of securities, other than IPOs, directly into a secondary market without the services of an underwriter. The invention permits the primary issuer to define all conditions of the primary sale including the number (e.g., by value and/or volume) of new securities sold, the date and time the securities are sold and the price at which the securities are sold. By carrying out the sale of primary issuances without the services of an underwriter, the issuer is able to substantially lower the transaction costs for carrying out a primary issue.

### SUMMARY OF THE INVENTION

It is an object of the invention to provide a method, system, market environment, computer program product and/or financial product for selling a primary security.

It is an object of the invention to provide a method, system, market environment, computer program product and/or financial product for a primary issuer to sell a primary security on a public exchange on which earlier-issued securities that are fungible with the primary security are sold.

In a further object of the invention the primary security is a registered shelf offering of shares of stock and the primary issuer is a publicly traded company whose shares of stock are traded on a national exchange.

In a further object of the invention the primary issuer is connected to a public stock exchange through a communications network that transmits the primary issuer's offer to sell primary securities to buyers.

It is a further object of the invention to provide a market environment for primary issuers to sell primary securities without the services of a conventional underwriter, broker and/or placement agent.

It is a further object of the invention to provide a method for selling newly issued shares of stock selectively by a primary issuer onto an exchange such as the NYSE to obtain the real time pricing existing on the exchange at the time of the sale or the primary securities can be sold to a community of private buyers.

It is a further object of the invention to sell primary securities that are registered primary issues in the form of shelf offerings that are tradable on exchanges and fungible with corresponding earlier-issued securities sold on exchanges in a secondary market.

It is a further object of the invention that the sales of primary securities include stock held in treasury.

It is a further object of the invention to reduce the primary issuer's transaction costs associated with sales of primary issues from as much as 8% of the selling price to pennies a share.

It is a further object of the invention that sales of primary securities are conducted on a public and compliant exchange.

It is a further object of the invention that the sales of primary securities are carried out with the services and/or aid of a mediator, facilitator and/or custodian who is inter-networked to communicate between buyers of the primary securities and the issuers of primary securities through an inter-networked private communications system. It is a further object of the invention that the mediator and/or custodian carry out tasks related to settlement such as confirming orders through email, providing escrow facilities, facilitating delivery of securities at settlement, etc.

It is a further object of the invention that primary issuers sell primary securities such as new shares of stock using a dedicated communications system. Access to the communications system is available only to those primary issuers who are legally bound to deliver and complete settlement for primary securities sold on a compliant exchange.

In a further aspect of the invention the primary sales of primary securities is carried out using a communications system/network that permits instantaneous communication between primary issuers, buyers, optionally a mediator, facilitator and/or custodian and the exchange on which a secondary market is active. Components include devices such as mobile telephones, desktop terminals and access gateways to public and private communications networks including the internet.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 shows a flowchart of actions and decisions that are included in one aspect of the invention;

FIG. 2 shows a depiction of a market environment of the invention in which the primary issuer is inter-networked to a public exchange sponsoring a secondary market, buyer of securities and a mediator;

FIG. 3 shows the flow of actions that precede, initiate and terminate a shelf offering;

FIG. 4 shows the influencing factors that affect the pricing and selling decisions of a primary issuer;

FIG. 5 shows an aspect of the communications network and the interrelated nature of servers carrying out different functions of aspects of the invention;

FIG. 6 shows price variations of a security traded on a public secondary exchange;

FIG. 7 shows the relationship of a mediator, custodian and/or facilitator with respect to the primary issuer;

FIG. 8 shows a diagram of an aspect of the communications environment which may be used to implement one or more aspects of the invention.

### DETAILED DESCRIPTION OF THE INVENTION

Unless otherwise stated herein, the terms used to describe and claim the invention take those definitions described in Rule 405 of the Securities Act of the United States or as they are otherwise defined in the “Dictionary of Business Terms,” 3^{rd} ed., J. P. Friedman, published by Barron's Business Guides (2000).

A primary issue is the first sale of a security. The sale of the security transfers ownership of the security from a primary issuer (e.g., a company issuing new shares of equity) to a buyer. In the context of the invention, a primary issue does not include an initial public offering but instead includes only those sales of securities for which a secondary market for previously issued securities has been established on a national exchange. The primary issue of a security may be facilitated or handled by any of an intermediary, custodian or broker (facilitator). Primary securities that are directly sold onto a public exchange by a party other than a primary issuer are still primary securities because the sales of the primary security is the first sale of the security on a public exchange.

A primary security is a security that is to be issued and sold on a public exchange for the first time. The primary security is sold as part of a shelf offering by the primary issuer that is issuing the security. After sale on a public exchange as part of a primary issue, the primary security becomes a secondary security and is freely traded on the exchange and fungible with corresponding earlier-issued securities. A primary issuer may also be a seller or buyer of secondary securities.

Primary securities include securities that are a collection, package or derivate of earlier-issued securities. For example, the invention may be applied to closed-end funds which issue new shares of stock that are indexed to the price of an underlying basket of stocks sold on a secondary market. The stocks of the underlying basket may be freely traded in a secondary market before during or after the primary issue is offered for sale. On formation of a closed-end fund predetermined amounts and/or values of secondary securities are purchased and held in a basket. The value of the basket is represented by the price at which the closed-end fund trades on a secondary market. Shares of the closed-end fund are issued as a primary security separately and distinctly from the issuance of any shares of the stocks that are included in the basket of stocks of the closed-end fund.

Other securities that may be included as primary securities of the invention are based upon derivative securities such as collateralized debt obligations (CDOs) and collateralized mortgage obligations (CMOs). Securities representing groups of debt obligations or other obligations and/or rights may be assembled such that the intrinsic value of the underlying securities represents a composite value reflected in the valuation of a new security that may be the primary issue of the invention. The first sale of such a security on a public exchange is a primary issue in the context of the invention so long as it is a shelf offering that has undergone conventional regulatory approval and review.

In one embodiment of the invention the primary issuer may issue or offer for sale options or warrants for the purchase of the primary issue. The options give a buyer the right to purchase the primary issue securities at a predetermined price prior to, during and/subsequent to the issuance of the securities on the secondary public exchange. Likewise the primary issuer can sell or offer for sale warrants for the purchase of securities of the primary issue. The warrants may be used as an inducement fro the sale of other securities. For example the primary issuer may offer for sale debt securities offering a certain rate of return and, in addition, warrants to purchase an upcoming or concurrent primary issue at a predetermined price or at a price that is a preset fraction of the actual issuance price of the primary issue.

A primary issuer is a business entity such as a company, bank holding company, and/or corporation which authorizes and approves the issuance and first sale of a security according to the rules of its charter. Primary issuers includes companies and business entities that conduct a primary issue of securities. Issuers include well-known seasoned issuers (WKSI), seasoned issuers, unseasoned issuers and non-reporting issuers. In a preferred embodiment of the invention the issuer is a WKSI.

Primary issuers are preferably companies and/or corporations having stock publicly traded on a national exchange. In order for a primary issuer to be listed and/or traded on a particular exchange, the primary issuer must meet the listing and/or trading requirements of the exchange. The listing requirements, generally set by an exchange's board of governors, are a set of conditions imposed upon companies that want to be listed and/or traded on the exchange. Among securities exchanges around the world, listing requirements vary and reflect criteria such as minimum number of shares outstanding, minimum market capitalization, and minimum annual income. For example, companies must meet specific financial and liquidity requirements to have their securities listed on the NASDAQ Global Select Market™.

Preferably, a primary issuer must meet all of the criteria under at least one of three detailed financial standards, each one mandating requirements under pre-tax earnings, cash flows, market capitalization, revenue, bid price, market makers, and corporate governance. Specific liquidity requirements may include the number of beneficial shareholders, publicly held shares, and market value of publicly held shares. The New York Stock Exchange (“NYSE”) has minimum quantitative standards of distribution and size criteria and financial criteria. Criteria to be listed on the NYSE may onclude 2,000 holders of a unit of trading or 2,200 total shareholders, together with an average monthly trading volume of 100,000 shares or 500 total shareholders, together with an average monthly trading volume of 1 million shares, 1.1 million outstanding public shares, and a market value of public shares being $100 million for public companies and $60 million for IPOs, spin-offs, carve-outs and affiliated companies. When a primary issuer falls below any criterion, the NYSE may review the listing and extinction of any then-pending shelf offering.

A secondary market is a public exchange on which securities are transferred between unrelated parties for good and valuable consideration, most often cash. Secondary markets include national exchanges, foreign exchanges and international exchanges. A secondary market provides a market on which an owner of a security exchanges the security for cash.

A secondary security is a security that was previously issued and sold on a public exchange. Any sales of a secondary security on a public exchange are sales in the secondary market. Sales of secondary securities that occur privately and not on a public exchange are still characterized as secondary securities because the securities are sold after their initial and/or primary issue. Securities that are reissued by a party that purchased earlier-issued securities from an exchange are primary securities only if their reissue requires separate or unique regulatory approval. The sale of an issuer's securities such as treasury stock is not a primary issue even if sold by the original issuer unless the securities have been both retired and reissued under separate regulatory approval.

Secondary securities are those securities earlier-issued by companies and business entities but now owned by one or more other parties such as individual investors, mutual funds, investment holding companies and the like. Secondary securities are freely bought, sold and transferred between unrelated parties acting through the exchange. The sale of the secondary securities occurs in the same manner that, e.g., common stock, is sold between buyers and sellers on a national exchange.

Secondary securities are offered for sale by sellers at prices that vary over time. Buyers offer to purchase secondary securities at prices that may be the same as the price offered by the seller or buyers may offer a price lower than the seller's price in hopes of enticing a different seller to sell the security at a relatively lower price. The exchange provides a fluid system of offers to buy and offers to sell of the secondary security. The buy and sell offers provide a basis for establishing a market price in the secondary market. The market price established in the secondary market is preferably the price at which the primary issuer offers the securities of the primary issue for sale.

Ordinarily, secondary sales are conducted with the services of a broker and/or settlement agent, transfer agent and/or market maker. Sales of secondary securities do not require the intervention or services of an underwriter. The primary issuer's sale of a primary issue may likewise make use of the services of any of a broker, settlement agent, transfer agent and/or market maker.

Securities include common stock, preferred stock, debt, convertible debt, non-convertible debt, warrants, options and other rights. Preferably, the security which sold in one aspect of the invention is in the form of newly issued shares of equity (e.g., common stock).

Debt securities include, without limitation, high-grade bonds, high-yield bonds, emerging market bonds, agency bonds, municipal bonds, and European fixed-income products, including Eurobonds, European high-yield bonds, and European-dominated emerging markets bonds. Moreover, the invention can be adapted for use with futures and debt security products.

In the context of the invention a security that is “the same as” or “indistinguishable” from another security is freely exchangeable and in parity with the other security such that a buyer and/or investor has no preference over one or the other. Indistinguishable securities may be identifiable and/or different from one another according to issue date, par value, physical form (e.g., stock certificates of different design or markings). Securities that are “the same as” or “indistinguishable” from one another may not be identical because such securities may have different issue dates, different serial identifiers, or may have other characteristics that do not affect the value of the underlying security but nonetheless permit its tracing by a specific identifier (e.g., serial number) of the security and/or have cosmetic differences. Two or more securities that are “the same as” or “indistinguishable” are capable of mutual substitution, e.g., such securities are fungible.

The primary securities sold by the primary issuer on the exchange do not have to be exactly the same as all of the other securities of the same type previously issued and/or offered for sale by the primary issuer. For example, the primary issuer may offer for sale primary securities in the form of common stock that have different rights and/or a different market price in comparison to secondary shares of preferred stock. Investors and buyers of both the preferred and common stock readily distinguish the two types of stocks and must identify with particularity which stock they wish to purchase on the exchange in order to consummate a buy or sell transaction.

A registered shelf offering (hereinafter “shelf offering”) is a primary issue that meets applicable regulatory and exchange rules and/or guidelines for issuance and sale on a national exchange. For example, in the United States a registered shelf offering is one that meets the requirements under Rule 415 of the Securities Act. Registered shelf offerings include automatic shelf offerings, continuous shelf offerings, delayed shelf offerings, mixed shelf offerings and other registered securities sold or issued through, for example, dividend or reinvestment plans (DRIPs), securities issued on conversion of existing or to-be-sold options, warrants or rights, and registered securities to be used in connection with a business combination transaction.

A shelf offering is a primary issue for which the primary issuer has obtained regulatory approval. The shelf offering status is a regulatory characterization of a regulatory agency's permission for an issuer to issue a predetermined number and type of securities without separate regulatory approval for each issuance. The regulatory approval pre-registers a new security in the absence of an agreed upon issue date. The issue date may be delayed for a period of several years after regulatory approval of the issue. Shelf registration allows securities to be issued quickly without delay of further regulatory review. Shelf registration permits an issuer to complete registration-related procedures and regulatory review beforehand and quickly market new securities for cash when conditions are favorable.

A shelf offering may include a mixed shelf offering in which two different types of securities are issued in a primary issuance concurrently or in series or a combination thereof. The primary securities of a mixed shelf may differ in type, for example, a first security may represent stock and a second security may represent debt, or the securities may differ in kind, for example, a combination of preferred stock and common stock.

The shelf offering is most often registered and/or submitted for regulatory approval through the SEC Form S-3. The primary issuer publishes information relating to the targeted selling price, the amount of securities to be sold, the type of securities to be sold, and any dilutive effect the primary securities will have on financial metrics such as “earnings-per-share”. Because the primary shares, once sold on a secondary market, are indistinguishable from earlier-issued securities traded as secondary securities on the exchange, the primary securities do not suffer from prejudice and/or depressed market price in comparison to those shares already freely exchanged as secondary securities on the Exchange.

In the invention the primary security is sold on a public exchange such as a national exchange (e.g., NYSE, NASDAQ, ASE) and/or a foreign exchange. The exchange is preferably a national exchange which provides a marketplace for the sale of secondary securities. In the invention, the first sale of the primary security to the public is on the exchange and is preferably the first transfer of ownership of the primary security. The exchange is compliant; meaning, the exchange meets applicable regulatory approvals. In the United States a compliant exchange includes national exchanges regulated by the SEC such as NYSE, ASE and NASDAQ.

In one aspect the invention includes a method, system, market environment, financial product and/or computer program product for selling a primary security. Preferably no other sale of the security occurs prior to its primary sale on the public exchange. In one embodiment of the invention a private sale of the securities is carried out before the securities are sold on a national exchange. The private sale may occur without the regulatory approval necessary to conduct a public issue. The new owner of the securities may subsequently seek regulatory approval in the form of a shelf offering for the primary issue of the securities according to the invention. However, the securities are not subject to any new or heightened regulatory review for a shelf offering if the post private sale of the securities occurs on a secondary market.

The primary security of the invention is essentially the same as one or more other securities previously issued by the primary issuer (e.g., a company or business entity), for example, securities initially or earlier sold or issued by the primary issuer in an IPO. The primary security includes the same rights and has the same intrinsic value of the earlier-issued security. Earlier-issued securities are those securities which were issued and sold on a national exchange prior to the issuance and selling of the primary security and were subject to a different regulatory approval process, were authorized by the primary issuer after the earlier issued securities were authorized and/or were issued or sold during a different sales period.

Preferably, the primary issue is described in regulatory documents submitted separately from the regulatory documents submitted by the issuer for the regulatory approval of any earlier-issued security. The earlier issued security preferably was subject to a separate review by the regulatory agency responsible for approving the sale of new securities on a public exchange (e.g., SEC). The primary issue preferably includes securities that were authorized by the primary issuer separately from and subsequent to the authorization the earlier-issued securities that are traded in the secondary market on the exchange while the primary issue is being sold on the exchange.

In embodiments of the invention the earlier-issued security was issued, approved by a regulatory agency, or authorized by a board of directors at least one year, at least two years, at least three years or any multiple of these periods before the primary issue.

Securities such as shares of equity (stock) in a corporation are issued under the direction of a Board of Directors. The shareholders and/or owners of the corporation limit the number of securities that may be issued by the Board of Directors, e.g., the shareholders authorize the Board of Directors to issue securities but limit and/or specify the number and type of securities. The number of authorized shares of a corporation is equal to the number of total shares but the number of authorized shares may be grater than the number of issued shares.

The invention may further include embodiments in which middle and back office functions carried out by an intermediary, facilitator and/or custodian for any aspect of trade support, settlement, position valuation, and confirmations, e.g., using Extensible Markup Language (XML).

In certain aspects of the invention the primary issuer arranges sale of the primary security through one or more intermediaries or brokers. The intermediary may be a clearinghouse, market maker or a party having a seat on an exchange. The primary issuer may arrange sale of the primary security through the broker or intermediary contractually such that the primary issuer represents and guarantees delivery of the primary securities to the party carrying out sales on the national exchange on the primary issuer's behalf.

It is a feature of the invention that the sale of primary securities on the exchange does not require the services or intervention of an underwriter. Thus the only party at risk of failing to sell the primary securities is the primary issuer. If the primary issuer fails to sell the desired quantity or value of securities the financial consequences fall only on the primary issuer. Of course, the primary issuer may delay or withhold further issuance of securities until such time as it is possible to sell the desired quantity of securities on a secondary market or otherwise obtain capital. It is preferred that the primary issuer's sale of the primary issue does not involve any agreement of exclusivity with any particular buyer. It is preferred that the primary issue is sold openly on a national exchange through any channel or sales path that provides the lowest transaction costs.

Issuance without an underwriter also means that the primary issuer is not guaranteed to receive cash and/or sell the entire number of securities authorized and approved for issuance. The primary issuer is at risk that the market price on the exchange (as defined by the secondary market) falls to a level that provides less than anticipated sales income from the primary issue. Alternately, if the security sells for a higher price than expected (e.g., the secondary market prices is higher than expected), the primary issuer obtains full benefit of the unexpected or unplanned overage.

Securities that are underwritten are those securities for which the issuer receives a guarantee of sales from a third party such as an underwriter. Underwritten securities provide an issuer with a guarantee of funds because the issuer will be paid for any securities issued but not sold during their initial sale on an exchange. Preferably, in the invention, the securities of the primary issue are not underwritten or are only partially underwritten.

The primary security is sold on the national exchange in a manner that makes its characterization as a primary issue transparent and/or irrelevant to a buyer or potential buyer. Financial regulations, e.g., the regulatory process by which a primary issue is approved, ensures that the public knows that the primary issuer is or will be selling primary securities. Such information becomes publicly available through the primary issuer's registration of the sale of securities with, for example, the SEC. The primary issuer's direct sale of primary securities on a secondary market is not made in violation of any disclosure requirements because such requirements are met in advance when the primary issuer applies for regulatory approval to carry out a shelf offering.

Some trading systems such as the Bloomberg terminal may provide identification characteristics by which a seller can determine the origin and/or seller of the securities of a primary issue being offered for sale on the national exchange. For example, certain proprietary trading systems may be able to identify electronic coding or labeling which distinguishes the primary issuer's offer to sell from the offers to sell of sellers of the secondary security. This, however, has no effect on the price the primary security is offered for sale on the national exchange. The invention may provide an improved degree of transparency and/or improved anonymity for the primary issuer.

Conventionally some primary issues such as IPOs have been conducted such that the public has limited access and/or restricted participation to the primary issue. Conventional underwriting methods often make it difficult to discern all of the parties having a stake and/or having an influencing capacity on the sale or success of a primary issue. In the invention, a primary issuer that is directly issuing primary securities on an exchange eliminates the involvement and perception of non-transparency that is sometimes associated with underwriting.

Alternately, the primary issuer may act anonymously when selling primary securities. In this embodiment of the invention the primary issuer preferably uses the services of a broker, market maker or facilitator to carry out direct interaction with the secondary market, e.g., exchange. The primary issuer receives proceeds of the issue based on the market price at which the primary securities were sold minus any applicable fee and/or transaction costs incurred by the intermediary in facilitating the sale. By using an intermediary, such as a market maker, the source and/or nature of the primary security is not evident to the secondary market and thus may lessen the likelihood that the market reacts negatively to the issue in a manner contrary to the established secondary market price.

It is a benefit of the invention that the public is provided with uniform access to primary securities. By permitting the direct sale and/or issuance of primary securities onto a secondary market, the primary issuer democratizes the issuance of primary securities.

The primary issuer's sale of the primary security may include transaction costs that are equivalent to the transaction costs associated with the sale of secondary securities on the exchange where such sales are similar in time or quantity. Such transaction costs may include an SEC fee, a settlement fee, a fee charged by the exchange, and optionally, a flat, variable or fixed fee or commission charged by a broker or intermediary for conducting sale, transfer, settlement and/or other custodial fees associated with the sale of the primary issuer's primary securities.

In the invention the transaction costs for the primary issuer are substantially lower than the transaction costs that would otherwise be incurred if the primary issuer utilized the services of an underwriter to market and sell the primary shares and/or used other conventional means to sell primary securities.

In a transaction utilizing the services of an underwriter to sell a primary issue, the issuer of the securities would contract for the sale of all of the primary securities through an underwriter which may include one or more unrelated parties such as a syndicate or one or more investment banks. In return, the underwriter would guarantee the sale for cash of a portion of the entire issue of the primary security at a predetermined price. Any change in the market price of the corresponding secondary security would have no effect on the proceeds received by the primary issuer on sales made through an underwriter.

The cost to the primary issuer for this service is substantial and includes the underwriter's fee or commission which may be as much as 8% of the proceeds of the sale of securities. Equally disadvantageous is the underwriter's influence on the offering price of the primary security. It is in the underwriter's interest to price the primary security at a level which guarantees that the entire amount of the primary security will be sold at a price at which the underwriter can expect an incremental gain in the market price of the security such that the underwriter reaps the benefit of any capital appreciation in the market price of the underlying security.

Further disadvantageous to the issuer when using the services of an underwriter is the inability to select particular times for selling the primary security. The nature of a secondary market such as a national exchange includes price fluctuations and variations of securities. Prices for particular securities vary over time with substantial differences between market highs and market lows. By using the services of an underwriter a primary issuer may lose the ability to time sales of primary securities to take advantage of favorable market conditions to thereby maximize the market price at which the primary issue is sold. In the invention the primary issuer can exploit the advantage of a shelf offering by selling securities opportunistically under market conditions which favor the primary issuer.

The primary issuer may sell the securities on the exchange using any conventional offer technique. For example, the primary security may be offered for sale of the exchange in the form of a market order which is an instruction to sell the securities at the current market price. A market order is usually executed quickly as long as there are active buyers in the market. The primary issuer may place a market order without regard to the bid and ask spread. Sell orders are filled at the bid price, i.e., the price an anonymous buyer is willing to pay for a certain number of securities. The buyer can agree to buy the security by the number of securities (e.g., the total number of shares of stock) or by a total or aggregate dollar value.

A limit order is used by the issuer to set a limit on the sell price, e.g., a lower threshold price under which the issuer is not willing to sell the security. A limit order is only executed when the buyer agrees to pay at least the issuer's limit. The issuer risk failure to execute the sale if price for the security on the secondary market falls.

A stop order can be used to set a limit under or over which no further primary securities are sold. The stop order can be used to discontinue sales of the primary issue if the price on the secondary market has fallen below a desired threshold. Stop sell orders are placed below the current market price and can be converted to a market order when the security price on the exchange reaches the stop order price. The strategy may be used when it is desirable to sell a certain number of units of a security regardless of the total sales income. The stop order frees a primary issuer from monitoring the secondary security price

A stop-limit order can be used to protect a foundation or floor price for the secondary security on the exchange. A stop-limit order turns into a limit order when the stop price is reached to give more control of the timing of primary security sales.

A day order provides a means by which the primary issuer can place a sell order, e.g., defined by minimum price or other conditions, that remains in effect for only a single day of trading on the exchange.

A good until canceled order remains an open offer to sell the primary security at a fixed price until the order is filled or the offer to sell is withdrawn (e.g., canceled) by the primary issuer. This type of order can remain open and pending for an indeterminate time period.

A fill or kill order can be used when it is desirable to sell a defined quantity of securities immediately. The fill or kill order allows the primary issuer to test the market for support under certain price or supply conditions.

Other order types including any of trailing stop, trailing stop limit, one cancels other, contingent orders, triggers, market on close, and limit on close may be used by the primary issuer when selling the securities.

Primary issuers may use different types of intermediaries, facilitators, custodians and/or brokers to improve liquidity and/or take advantage of market conditions to sell amounts of primary securities. The intermediaries or brokers may provide any kind of transaction aid such as block trading desks, security exchanges, auction forums, and electronic communication networks (ECN). Primary issuers may also divide orders over time and by destination into smaller sized orders to aid in liquidity.

Alternately the primary issuer may use an order matching system for executing sell orders without disclosing to the marketplace the precise details of price, quantity, or type in order to avoid impacting the price in the marketplace. Large orders can thus be entered into an order matching system without depressing the price of the secondary securities. Instinet is an example of an order matching system which operates an electronic trading system that allows primary issuers to place offers for sale anonymously instead of through direct human-to-human negotiation on the trading floors. Instinet permits matching of sell orders to one or more counterparties and/or buyers.

In another aspect of the invention the primary issuer delegates placement and/or execution of sell orders to a computer automated trading system. Alternately the primary issuer uses a computer model to determine selling opportunities then manually completes the sale of securities.

The automated system may use formulas for determining optimum times for selling the primary securities. A wide range of different types of evaluation models, computation methods, formulas and the like can be used to select selling opportunities and/or to execute sales. These systems may rely on pricing information that is internal (i.e., specific to the pricing for the secondary security on the exchange) or both internal and external (e.g., information that is external to the exchange such as interest rates). Typically, each strategy uses one or more internal or external data inputs, weighting factors, and pricing strategies such as spreads etc.

In one embodiment of such a model, the primary issuer inputs variables corresponding to the prices at which the primary issuer is willing to sell over a period of time, with each amount being initiated at different points on a schedule. In another model the primary issuer determines executable and/or target pricing or quantity using a predetermined weighting factor and a generalized index value. A generalized index value can be provided by a preselected data source for a particular item in a particular field of operation, which can be represented by index (e.g., data source, item, field). Another model drives an offer price or quantity by multiplying a weighting factor with a generalized index value and adding the result to a second weighting factor. Offer prices and/or quantity could likewise be derived from a combination of weighting factors and/or constants in relation to one or more indexes (e.g., S&P 500). Further still a plurality of constant values, weighting factors, generalized indexes and/or other external data can be used to model the sales of the primary issue.

The models, formulas, strategies, etc. can be used to determine and/or specify the specific value of an order characteristic for order price, order quantity, as well as an order satisfaction density profiles (e.g., to combine price and quantity guidelines/thresholds based numeric thresholds or standards including for example choice of transaction destination, order matching system, segmentation of an aggregate order between multiple destinations, means of delivery, quality standards, credit standards, as well as many other conventional transaction related or financial instrument or commodity related characteristics). Models and algorithms such as those used for exchange-based derivative trading can likewise be used.

In one embodiment securities of a primary issuer are offered for sale in response to market indicators. The market indicators represent statistical, quantitative and/or subjective inputs derived from the secondary market of the exchange on which the primary issue is sold. In a representative example a primary issuer automates the sale of primary securities by programming their sale to a volume indicator. On days or during market periods when the sales volume of secondary securities corresponding to the primary securities and/or other statistically derived values keyed to the primary issue or other financial indicator, the primary securities may be offered for sale or the sale of the primary security may be suspended. In other embodiments the quantity of primary securities sold may be balanced such that certain ratios relating to the volume of secondary sales is maintained.

The sale of the primary securities may be set at levels such that the secondary market is essentially unaffected by the primary issuer's sale of primary securities. For example, by setting the volume of sales of primary securities to represent only a minor portion of the total volume of sales for the secondary securities, e.g., the sale of primary securities representing 0.1, 1, 2, 5, and/or 10% of the total volume of the corresponding secondary securities sold on the exchange.

Likewise, the sale or offer for sale of primary securities can be keyed to certain price targets. If pricing for the secondary security on a secondary market falls or rises above the target, the sales and/or offer for sale of the primary security may be suspended or accelerated, as deemed most appropriate by the primary issuer. Primary securities may have sale targets likewise keyed or targeted to price spreads, opening highs, closing lows and the like.

In embodiments of the invention the primary issuer publishes the price at which the primary securities will be sold in advance of any offer for sale. The price at which the primary securities are to be offered for sale may be greater than or less than any present market price. In one aspect of the invention all sales of the primary securities are made prospectively according to published pricing targets which are distributed to the public in advance of any offer for sale.

The primary issuer's planned and/or executed sales of primary securities may be published in a cumulative or running total on a time basis that is published or made available on the secondary market. A mediator, facilitator or custodian acting on behalf of the primary issuer and one or more other primary issuers may develop an index describing the pricing and/or sales performance of primary securities on a secondary market. The sales performance may be used as an index or predictive measure of market strength or confidence in a primary issuer's financial success. The index or composite of primary issues may itself be used as a feedback data point in setting sales targets such as sales price for any individual primary security.

In another aspect of the invention sales of primary securities are carried out during market times and at market conditions which are identified as conditions under which the secondary market is operating in conventional fashion. Such conditions may be keyed on volume, index performance, pricing spreads and/or any statistical derivation such as volatility or volatility indices. At times or under conditions which are identified as stable market conditions, an automated system may be triggered to offer the primary security for sale on the secondary market. One advantage of such a system is that a perception of fair dealing is transmitted to the secondary market. Further still, the primary issuer's intention to sell a certain value and/or number of primary securities may be announced to the public, for example, through the press release functions of a secondary market, so that advance notice is made of the primary issuer's intent to sell primary securities within certain price ranges.

In another aspect of the invention the sale of large blocks of primary securities is facilitated through the communications network described herein, over the exchange or separately therefrom. A primary issuer wishing to minimize repeated small volume sales onto a secondary market and further wishing to avoid intermediaries fees such as exchange fees and custodial fees may arrange for the sale of blocks of securities to a buyer. The sale of such blocks may occur privately or publicly. Preferably, the sale of blocks of primary securities are initially negotiated privately through the communications network. There is no restriction or condition on block sales which may be carried out at prices that are higher or lower than the price of the underlying shares on the secondary market. In this embodiment of the invention the transfer or sale of large blocks of the primary issuer's securities may be undertaken without disrupting the liquidity or pricing basis of corresponding secondary securities on the secondary market (e.g., exchange). The facilitator, broker and/or custodian is not paid an underwriter's fee and does not take on any risk of failure to sell the primary issuer. The facilitator, mediator and/or custodian merely acts in the function of a facilitator bringing together the buyer of a block of primary shares which a primary issuer wishes to monetize.

This embodiment of the invention may also be used to facilitate sales of primary securities to institutional purchasers such as mutual funds and stock index mutual funds.

In another embodiment of the invention the communications network and/or system of the invention permits communication and matching between business entities, corporations, companies, investment funds and the like in need of capital, with lenders and sources of capital. Those parties with capital to lend or invest bid on the capital needs of participants in need of capital such as the primary issuers of the invention. This aspect of the invention allows primary issuers to tailor sales of primary securities to particular buyers. Such sales and the use of the communications network are especially advantageous for securities that are illiquid or have a relatively lower level of liquidity in comparison to secondary securities such as shares of common stock sold on an exchange. For example, options and warrants which may be convertible, non-convertible preferred or common may be more easily sold and/or matched with a receptive buyer through this aspect of the invention.

The communications network may also function in an embodiment of the invention in which large blocks of primary securities are sold to particular buyers such as institutional buyers and mutual funds. In this embodiment of the invention the communications network includes a database of potential buyers. The investment and purchase resources of the database of buyers may be matched against information pertaining to any primary issue. For example, if a particular primary issue is expected to meet the threshold investment rate of return for a particular buyer, the buyer and the primary issuer may be matched to initiate negotiations towards a block sale of the primary issue. This embodiment of the invention preferably includes a private communications network in which negotiations between primary issuer, facilitator, and buyer are carried out, in initial stages, anonymously and later publically.

In another embodiment of the invention a database of primary issuers is assembled. The database may be accessed according to prescription or registration. Users registered in the database may describe their businesses and the function of primary issuers according to financial statistics, e.g., market capitalization, return on equity, and the like. Primary issuers may subsequently be matched with those parties having interest in particular investment opportunities relating to primary issues.

In one characteristic embodiment of the invention which is directed to a method for selling a primary security on a public exchange, the secondary market price of a security already offered for sale on an exchange in a secondary market is determined. The secondary market price of the corresponding secondary security is determined from publicly available information. For example, recent reports of purchases and sales of the secondary security may be used as a basis for determining the secondary market price. The secondary market price may be the same or substantially the same as the price at which the primary security is offered for sale. For example, if one or more sales of the corresponding secondary security occur at a price (X1$), the primary security may be offered for sale by the primary issuer or a party acting on behalf of the primary issuer at the same price (X1$). Because secondary market prices fluctuate during a trading period, the primary market price at which the primary security is offered for sale on the public exchange will likewise vary during a trading period and track the secondary market price.

The primary security may be offered for sale at a price that is substantially the same as the secondary market price. A price that is substantially the same differs by no more than $0.001, $0.002, $0.005, $0.01, $0.02, $0.05, $0.1, $0.2, $0.5, and/or $1 from the secondary market price existing at the time the primary security is offered for sale on the public exchange.

In another embodiment of the invention the primary issuer offers the primary security for sale on the public exchange at a price that is somewhat lower than the secondary market price. This strategy is a means by which the primary issuer may quickly sell shares of the primary security. Alternately, the primary issuer may offer the primary security for sale at prices exactly matching the offer prices pending for secondary securities on the public exchange at the time the primary issuer offers the primary security for sale. Such pricing strategies permit quick sale and disposal of the primary securities.

The primary issuer may offer the primary security for sale by directly placing a sell order on the exchange. The primary issuer may place such a sell order through a broker or other intermediary or, alternately, may directly place the order on the exchange's order management system.

The primary issuer sells the primary security to a buyer when the primary issuer's primary market price is matched to a buyer's offer to purchase securities on the secondary market. Such matching may occur by direct contact between the primary issuer and the buyer of the primary security or may occur through one or more intermediaries and/or may occur through an automated process over the exchange's order management system. The primary security offered for sale by the primary issuer at a particular primary market price is deemed sold when the primary issuer's offer to sell is matched with a buyer's offer to buy.

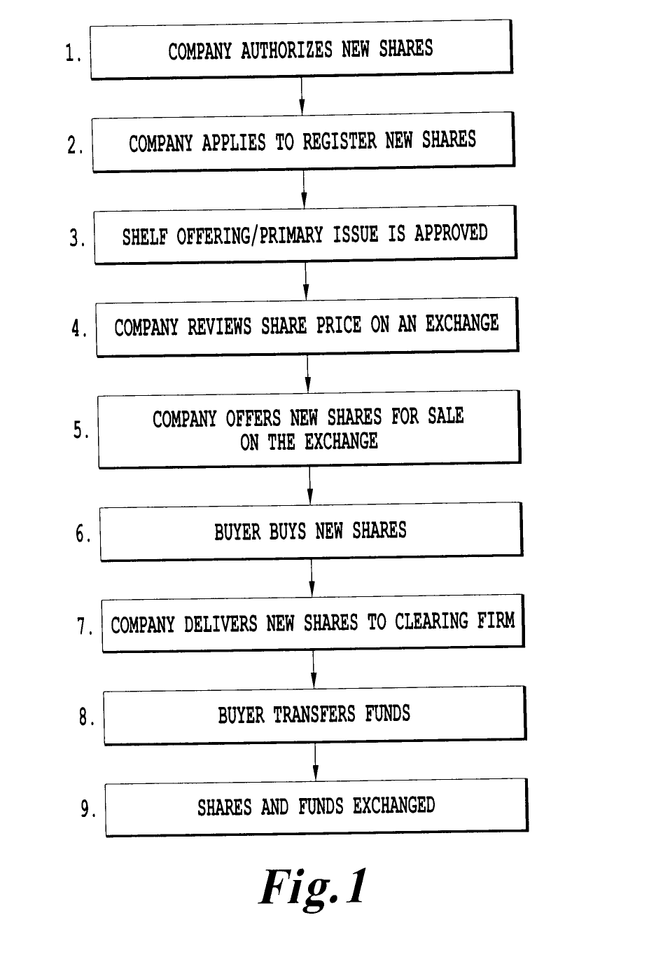

FIG. 1 describes a series of steps any of which may be a part of the invention and which provides a high level description of one or more portion of the invention.

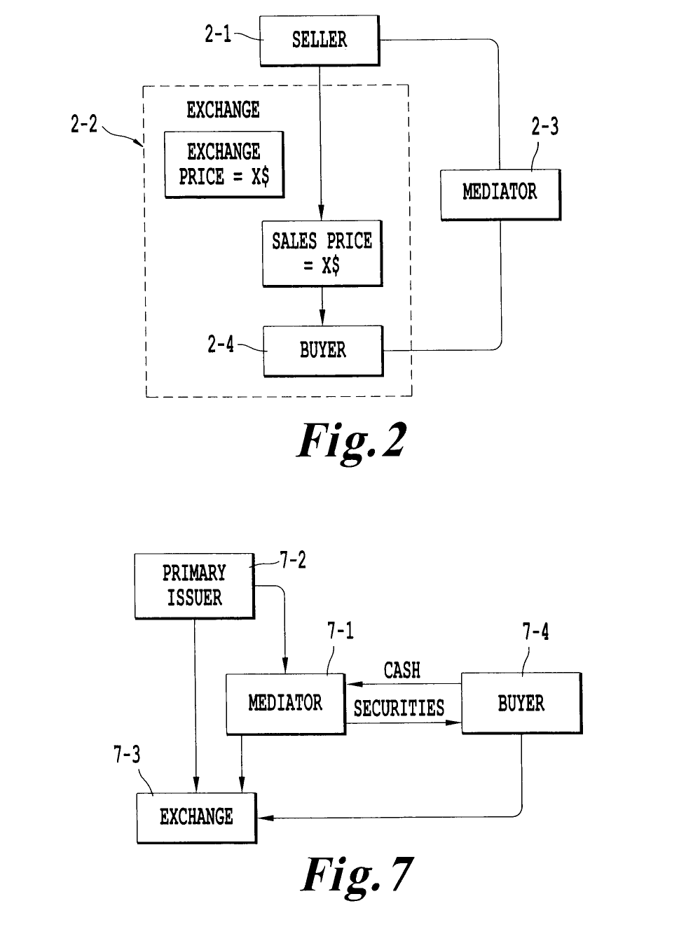

FIG. 2 provides a high level description of the market environment in which the invention is conducted. The seller (2-1) (i.e., primary issuer) communicates with an exchange but is otherwise separate from the exchange (2-2). The seller may use utilize the services of a mediator (2-1) (e.g., custodian and/or facilitator) or may interact directly with the exchange in a manner to reduce transaction costs and/or for convenience. The buyer (2-4) operates within the exchange such that the buyer's offer to purchase is generic and not specific to the particular securities to be issued and sold by the primary issuer and/or by a party on behalf of the primary issuer at a price X$ (2-5).

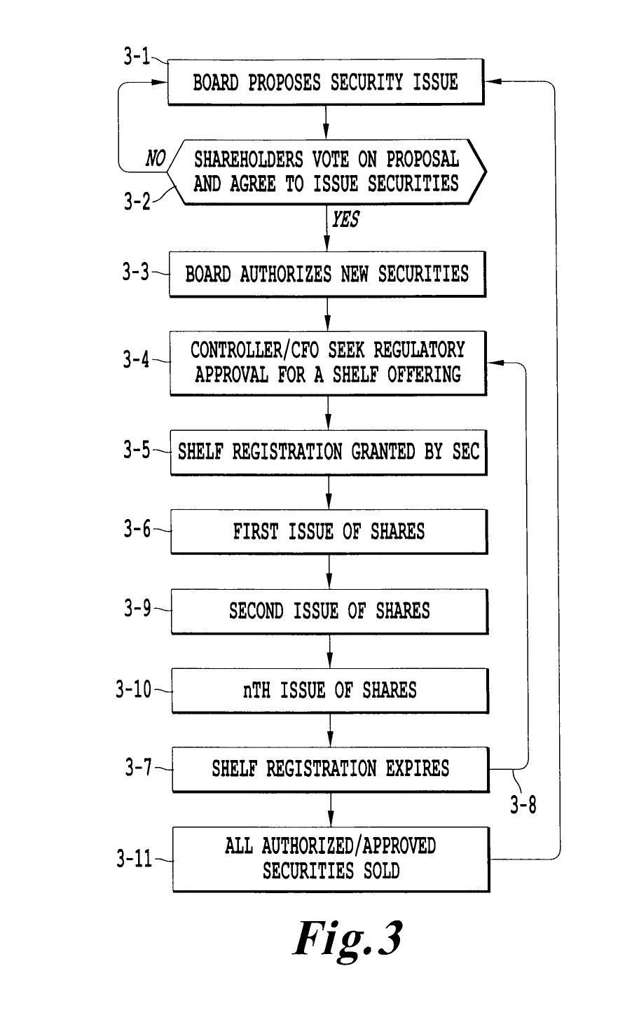

FIG. 3 describes steps which may be included in the invention for selling a primary security. Prior to any issuance of a primary security the board of directors of a corporation must obtain agreement from the shareholders to issue a security. Often the board approaches the shareholders with a proposal for a security issue (3-1). The shareholders, which may include one or more of the members of the board of directors, votes whether to consent to the issuance of additional securities (3-2). If the shareholders do not permit the board of directors to issue new securities the matter dies until the board of directors again submits a proposal seeking the shareholders consent to issue a new security. If the shareholders consent to the board of director's proposal to issue new securities, or if the shareholders consent to a modified proposal, the board of directors is given explicit permission to issue new securities. In most instances it requires only a majority vote for shareholders to reach agreement to permit the board of directors to issue new shares. In certain circumstances with particular securities such as warrants, options, rights, shares of preferred stock, etc., a super majority (e.g., more than 75% voting in favor) may be required in order for the board of directors to obtain permission to issue a new security.

After obtaining the shareholder's consent to issue a new security the board authorizes the issue of the security (3-3). The board of directors may only authorize the security under the conditions dictated by the shareholders (in most cases the details of the board of director's proposal originally submitted for shareholder review). The shareholders usually agree to provide the board of directors with authorization to issue an excess number of shares, e.g., a number or value of shares which is greater than the immediate capital needs of the corporation.

After authorizing the issue of new securities the board of directors, through the chief executive officer or other officer of the corporation, gives instructions to seek regulatory approval for issuance and sale of the new securities. The board of directors may instruct the chief financial officer (CFO) or controller of the corporation to obtain regulatory review and/or approval of the issuance of only a portion of those securities authorized for issue or, preferably, the board provides instructions for the controller or CFO to seek regulatory approval for issuance of all of the new securities authorized by the board and permitted by the shareholders. In a preferred embodiment of the invention the corporation seeks regulatory approving for a shelf offering (3-4).

After a period of regulatory review which may be short, e.g., less than 30 days for well-known seasoned issuers, a regulatory agency such as the SEC may grant regulatory approval for issuance of the new securities (3-5).

As part of the shelf offering the primary issuer is not required to issue all of the securities which are authorized or approved at one time. Under the conditions of a shelf offering the primary issuer may issue a portion of the authorized shares a portion of the approved shares in one or several selling episodes. In the context of the invention a selling episode is the sale of a group of securities over a period of time not to exceed a single reporting period such as a financial quarter of the primary issuer.

In a first issuance step (3-6) the primary issuer may issue an amount (Y1) of the new securities. The amount of securities (Y1) may be sold in a single transaction on an exchange or, more preferably, may be sold opportunistically over a period of days, weeks, months or reporting period on an exchange which is open for trading until all of the first amount (Y1) of the new securities has been issued and sold. The first issue/selling step may be repeated in further steps each of which sell and/or issue a further portion of the authorized and approved securities (Y2) (3-9) . . . (Y#) (3-10).

In an alternate embodiment of the invention the primary issuer constantly offers the new securities for sale on an exchange until such time as the regulatory approval of the shelf offering expires (3-7). Upon expiration of the period for issuance, the primary issuer may seek renewed regulatory approving for a shelf offering (3-8). Alternately, under conditions in which all of the new securities which were authorized and approved for issue are sold (3-11), the primary issuer may again seek permission to issue further securities by request to the shareholders (3-1).

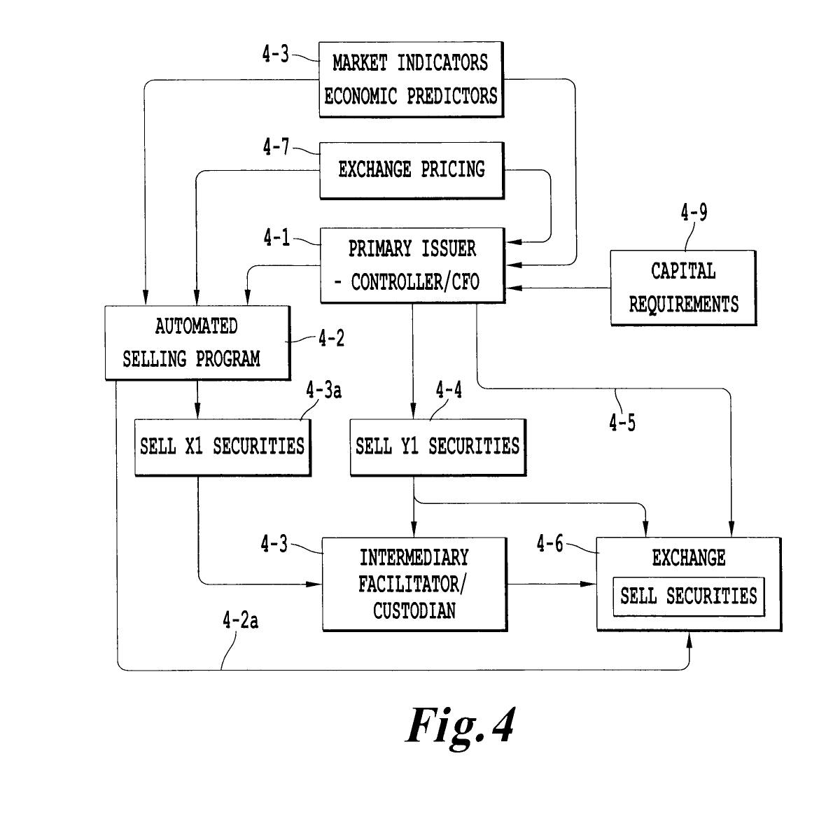

FIG. 4 describes feedback mechanisms and influencing data feeds that affect the pattern of sales of new securities issued in a shelf offering and/or affect a price at which a primary issuer offers new securities for sale on an exchange. Instructions for selling and issuing new securities that are part of a shelf offering are originated at the primary issuer, for example by a controller or CFO acting on behalf of a corporation which is the primary issuer (4-1). The controller may delegate selling responsibilities to an automated selling program (4-2) such that sales of the new securities of the shelf offering are carried out without the human assistance of the control or function of the primary issuer. The automated sale program may be an embodiment of the invention described herein in which sales volumes, prices and the like are keyed or indexed to financial indicators such as opening highs/lows, price spreads, volume and the like. The automated selling program (4-2) then directly and in an automated manner provides instructions to sell certain amounts of new securities at certain prices either directly to an exchange (4-2a) supporting a secondary market of corresponding securities or provide such instructions to an intermediary, facilitator or custodian such as a broker or market maker (4-3) which then places orders directly on the exchange or purchases such new securities for its own purposes (4-3a).

In another embodiment of the invention the controller function of the primary issuer provides instructions for issuing and/or selling new securities directly to the intermediary without the intervention of an automated selling program. The controller may give such instructions (4-4) in a generic manner identifying only the number of shares or may give more specific instructions by which the new securities are sold under only particular market conditions. Alternately, the controller function of the primary issuer may place a sale order directly on an exchange without the intervention of any intermediary such as a broker or market maker (4-5). The exchange (4-6) which provides a secondary market for the primary issuer concurrently processes buy and sell orders for securities that are the same as or indistinguishable from the securities offered for sale and sold by the primary issuer as part of the shelf offering. In a preferred embodiment of the invention the primary issuer has no effect on the market price in the secondary market other than those changes which occur due to changes in supply of new securities. Such changes do not appreciably affect the secondary market price (e.g., not more than e.g., 0.1%, 1%, 5% or 10%).

FIG. 4 also shows the influencing factors which act on the controller of the primary issuer. The controller may be cognizant or reactant to external economic indicators such as market indices (4-8). The controller may likewise be influenced or monitor the pricing of the securities of its competitors which may occur on the same exchange or on different exchanges. The controller likewise may monitor exchange pricing for corresponding securities traded on the exchange (4-7).

The primary issuer may also be influenced by or take into account internal data in providing instructions for selling the new securities (4-9). Internal indicators may include, for example, the capital needs of the primary issuer.

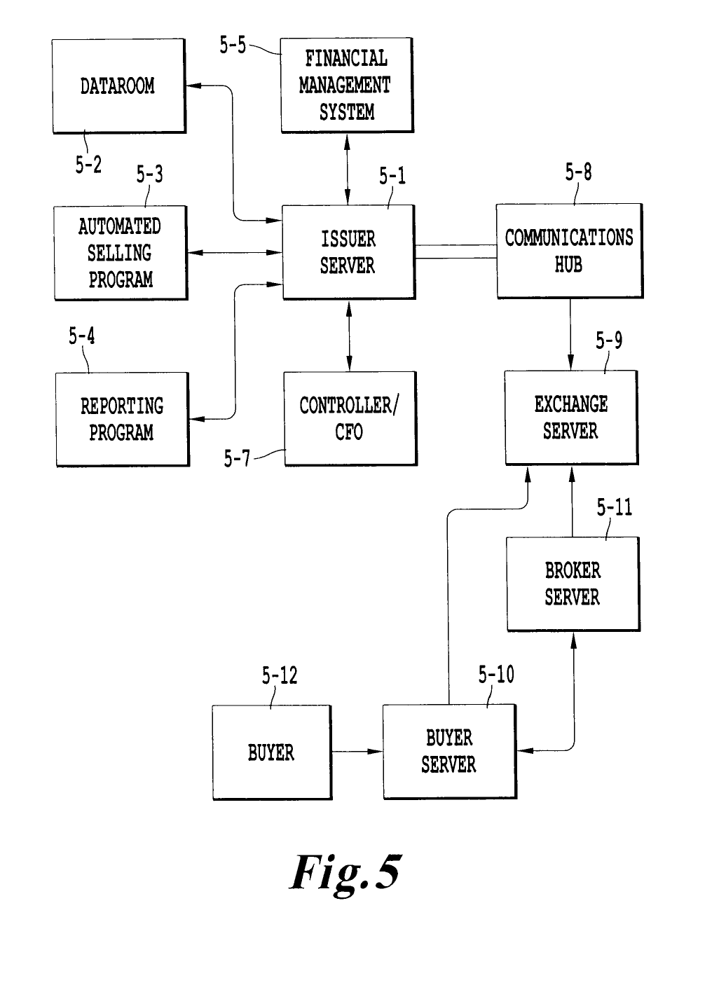

FIG. 5 shows an embodiment of the communications network which functions to connect the primary issuer with one or more of an exchange and a buyer of new securities. The primary issuer is in connection with the communications network through an issuer server (5-1). The issuer server itself is in communication, via landline or by physically separated devices, directly or indirectly, electronically or through other means, with servers representing functions such as a data room, automated selling functions and reporting functions (5-2), (5-3), and (5-4), respectively. The issuer server is preferably in direct contact and in control of any of the data room, automated selling function and/or reporting function servers. In essence, some servers are slave to the issuer server. The issuer server is also in direct communicative contact with a financial management system (5-5) which may function to maintain inventory of new securities and/or provide an indication of capital needs to the issuer server such that a running tally of new issue sales and capital income is maintained.

The issuer server is slave to one or more additional servers such as a CFO server (5-7) which is directly controlled and/or under the oversight of one or more individuals having responsibility for the financial matters of the primary issuer. The CFO server and/or any terminal network thereto, can provide instructions which guide the issuer server with respect to the sale and/or offer for sale of new securities to an exchange.

Preferably the issuer server is in direct communication with a communications hub (5-8) which provides instructions from the issuer server to an exchange and likewise communicates market conditions from an exchange to the issuer server. The exchange may be controller and/or accessible through one or more exchange servers (5-9) which freely communication with the communications hub and/or any of the other issuer servers or slaves thereto shown in FIG. 5.

A buyer server (5-10) is likewise in communication with the exchange server (5-9). The buyer server may be in direct communication contact with an individual or entity (Engls. trans) purchasing the primary issuer or may be controlled by one or more intermediaries such as brokers and market makers who receive instructions from a further buyer server (5-9).

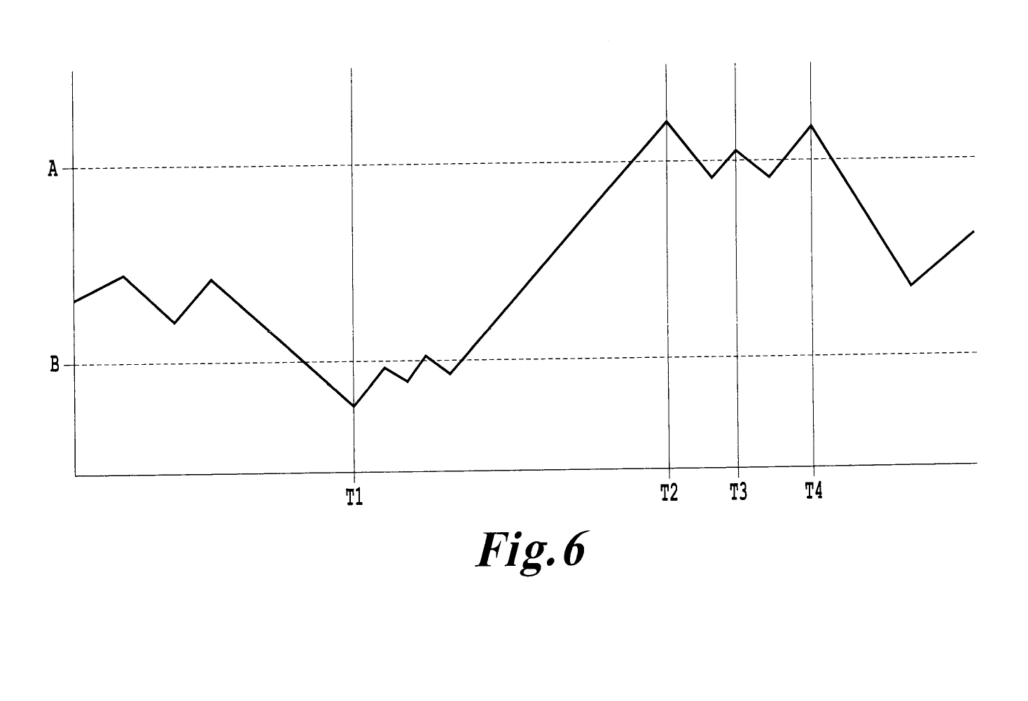

FIG. 6 describes the price of a security on exchange supporting a secondary market. The horizontal axis represents time whereas the vertical axis represents the price or a price condition of a corresponding security sold on the secondary market. Two price levels (A) and (B) are shown in FIG. 6. The sale of new securities of a primary issue may be programmed or instructed to occur at any point when, for example, the market price is above a minimum (B) and/or over or under a higher threshold price (A). In FIG. 6 the time point (T1) represents a period of low trading price on the exchange for securities which correspond with and are indistinguishable from the primary securities of a primary issuer. Preferably the primary issuer does not sell securities at time (T1) because at such a time the market price is relatively low and the total proceeds of sales of the new issue will be minimized.

On the other hand, the time periods (T2)-(T4) represent trading activity on the secondary exchange at which the corresponding secondary security is sold at a relatively high price, i.e., above the price threshold (A) of FIG. 6. The time periods (T2)-(T4) represent desirable opportunities for the primary issuer to sale and/or offer for sale new securities.

FIG. 7 shows how the functions of a facilitator, mediator and/or custodian may come into play in the sale of a shelf offering of a new security and a primary issuer. The mediator (7-1) provides optional services. Of course, the issuer (7-2) may interact directly with the exchange (7-3) without any services of the mediator, facilitator or custodian (7-1). In other embodiments of the invention the primary issuer acts first through a mediator and not directly to the exchange (7-3). The mediator (7-1) may offer a series of services for the benefit of the primary issuers (7-2). For example, the mediator may interact with the buyer (7-4) to arrange for and settle the transfer of shares from the primary issuer to the buyer and/or to accept cash from the buyer in exchange for the new securities sold by the primary issuer. Preferably the buyer has an arms-length relationship with the mediator (7-1). When placing an order on the exchange (7-3), the buyer (7-4) preferably interacts directly with the exchange or through a second mediator who offers services independently of mediator services offered to the primary issuer.

In another aspect of the invention the communications network described herein may include one or more database sources which provide financial and marketing information the primary issuer or the primary security. The databases may include services such as a video library which includes presentations made by the primary issuer describing the primary issuer and the highlights of the primary issuer; e.g., the primary issuer informs the public of its intent to use proceeds from the primary issue for a particular investment purpose.

The database may likewise include third party content. For example, the database may include analyst reports specific to the primary issuer, the primary issuer's intended use for funds derived from the primary issue, industry specific reports, company specific reports or any type of financial statistical information such as historical averages, price performance and the like. The database, e.g., data room, may be managed by the primary issuer or may be managed by a facilitator, custodian or mediator acting on behalf of the primary issuer. In one embodiment the database include road show presentations which describe aspects of the primary issuer's business and financial condition.

The communications network includes a communications routing connecting the primary issuer to a market environment that may include the exchange and/or another secondary market. The primary issuer may interact with the exchange and/or an intermediary such as a broker, facilitator or custodian, through the communications network. In one embodiment, a representative of the primary issuer monitors the market price of a soon-to-be-issued primary security in the secondary market as a function of a corresponding secondary security. The representative for the primary issuer opportunistically offers for sale amounts of the primary securities at prices which are believed to be in the interests of the primary issuer. The representative may be a human monitoring price information on a communications device such as a desktop terminal or a computer or automated device.

Sales of the primary securities may be made by using any communications device including electronic display and/or communications devices such as, but not limited to, mobile PDAs, cellular telephones, devices such as Blackberries, special purpose terminals such as Bloomberg terminals and the like.

The representative for the primary issuer may dispatch an offer to sell primary securities on a secondary market using conventional means such as those means which communicated with the exchange over a communications network. In one embodiment the representative for the primary issuer makes a telephone call to a broker, another representative or facilitator who is in direct communication with the exchange to indicate to the broker etc. that the primary issuer wishes to make an offer to sell. The representative may also be in direct contact with the exchange and/or any intermediary through other electronic communications means such as email, instant messaging, or any other electronic communications means supported by the networks and communications infrastructure described herein.

Electronic communications networks (ECNs) which are computerized trade-matching systems capable of uniting the best bid and offer prices can be used to maintain anonymity of the primary issuer and to reduce transaction costs. For example, ECNs may by-pass broker-dealer commissions as well as exchange fees. An ECN allows its participants such as brokers/dealers, market makers, and buy-side institutions to post bids and offers into a market quote system, such as the NASDAQ system.

The communications network and/or the system of the invention may include one or more servers, also referred to as a trading device which is preferably implemented by the use of one or more general purpose computers, such as, for example, a Sun Microsystems F15k having special purposes instructions, such as, for example, a typical personal computer manufactured by Dell, Gateway, or Hewlett-Packard. The trading device can include a microprocessor which can be any type of processor, such as, for example, any type of general purpose microprocessor or microcontroller, a digital signal processing (DSP) processor, an application-specific integrated circuit (ASIC), a programmable read-only memory (PROM), or the like. The trading device may use its microprocessor to read a computer-readable medium containing software that includes instructions for carrying out one or more of the functions of the trading device.

The trading device can include computer memory, such as, for example, random-access memory (RAM) or any type of computer memory or any other type of electronic storage medium that is located either internally or externally to the trading device, such as, for example, read-only memory (ROM), compact disc read-only memory (CDROM), electro-optical memory, magneto-optical memory, an erasable programmable read-only memory (EPROM), an electrically-erasable programmable read-only memory (EEPROM), a computer-readable medium, or the like. According to exemplary embodiments, the respective RAM can contain, for example, the operating program for either the trading device. As will be appreciated based on the following description, the RAM can, for example, be programmed using conventional techniques known to those having ordinary skill in the art of computer programming. The actual source code or object code for carrying out the steps of, for example, a computer program can be stored in the RAM. The trading device can also include a database. The database can be any type of computer database for storing, maintaining, and allowing access to electronic information stored therein. The trading device preferably resides on a network, such as a local area network (LAN), a wide area network (WAN), a virtual private network (VPN), or the Internet and preferably is connected to the network to enable electronic communications between the trading device and other communications and/or processing equipment over a communications connection, whether locally or remotely, such as, for example, an Ethernet connection, an RS-232 connection, or the like.

The system may have multiple, simultaneous roles in the primary issue invention; for example, as an aid for buying or selling securities. The system may access the exchange either through a separate interface or through a web interface provided by the CRA to submit data or through any other aspect of the communications network.

The method, system, financial product, market environment and computer program product of the invention can be implemented in hardware, software or a combination thereof. In one exemplary embodiment, the marketplace is implemented in software or firmware that is stored in a memory or computer readable medium, and that is executed by a suitable instruction execution system. Hardware may include any conventional hardware technology.

The term “computer-readable medium” as used herein refers to any medium that participates in providing data (e.g., instructions) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor, and the like. Transmission media may include or convey acoustic waves, light waves and electromagnetic emissions, such as those generated during radio frequency (RF) and infrared (IR) data communications, or any other wireless form of communication. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Devices that are in communication with each other need not be in continuous communication with each other, unless expressly specified otherwise. In addition, devices that are in communication with each other may communicate directly or indirectly through one or more intermediaries and/or the communications network. Additionally, a description of an embodiment with several components in communication with each other does not imply that all such components are required. On the contrary a variety of optional components are described to illustrate the wide variety of possible embodiments of the present invention.

Additionally, off-the-shelf software may be used to implement the present invention, such as, but MICROSOFT.NET, MICROSOFT SQL SERVER, or may be designed and programmed using any combination of languages, such as C++, JAVA, JAVA Script, XML, HTML, SQR, or PLSQL. One should understand that interfaces can be executed on a PC or the like, via a web browser over an electronic data network, such as the Internet. Further, interfaces may be executed on wireless client devices, such as PDA's or smart phones.

The invention provides an easy setup via a download from the web, provides security, e.g., using the Secure Sockets Layer (SSL) and dual-key encryption, provides established backup and recovery procedures, and includes third party data services (e.g., information from MoneyLine™ or other financial news services).

A further aspect of the invention includes means and devices for providing computer-implemented trading for primary securities including the step of providing respective computer-generated interfaces for a plurality of dealers and a plurality of investors. A network enables messages to be exchanged between the primary issuer interfaces and the buyer/exchange interfaces. Moreover, the primary issuers are enabled to communicate an inventory of most actively traded primary security issues, and bid and/or offer terms thereof, to the buyers via the buyer interfaces. The most actively traded primary securities are determined from a larger inventory of primary securities which are traded via the communications network and/or the exchange. Additionally, a buyer can submit an order, via the respective buyer interface, and based on the inventory, for trading a particular one of the most active primary securities to a dealer. In response to the inquiry, the dealer can communicate a message to the buyer indicating whether it accepts or rejects the offer, via its respective dealer interface.

Advantageously, the bid and/or offer terms of the most actively traded primary securities is updated substantially in real-time, and buyer are enabled to submit orders, via their respective buyer interfaces, to the primary issuers and/or dealers and/or intermediaries for trading the most actively traded primary securities without going through an inquiry procedure. For comparison, with the inquiry procedure, the buyers submit inquiries to the dealers regarding an issue, and the dealers respond with an offer. The buyer may then accept the offer, submit a counteroffer, or reject the offer.

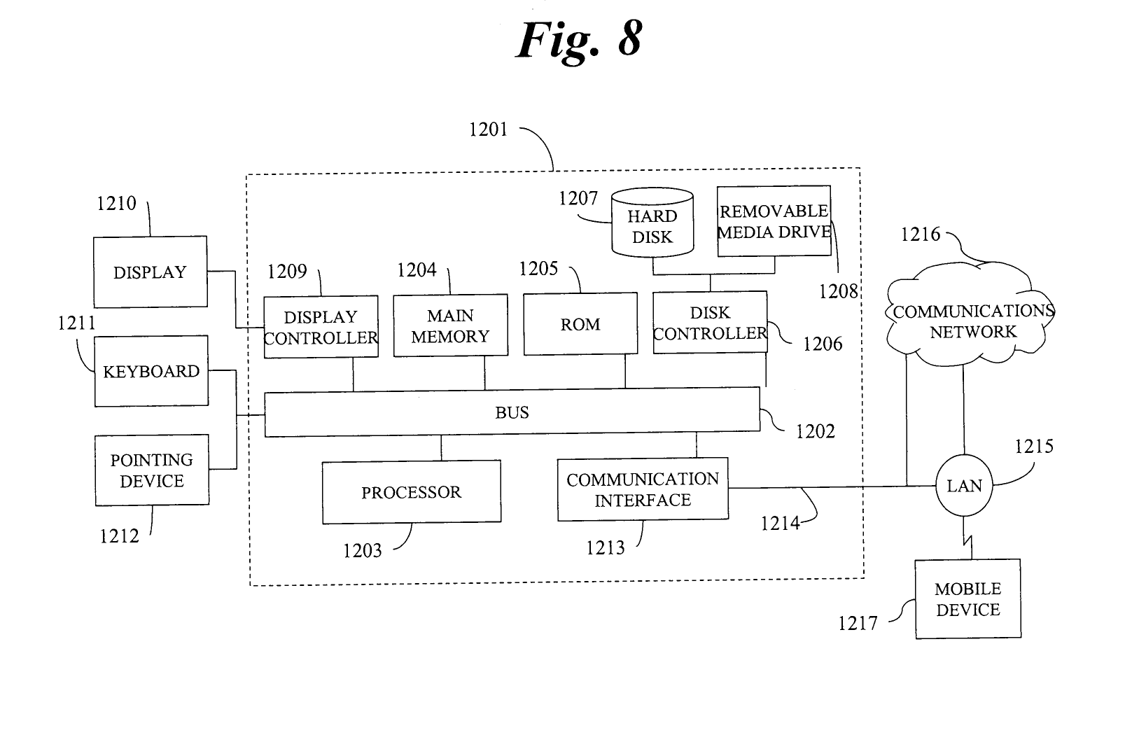

FIG. 8 illustrates a computer system 1201 upon which an embodiment of the present invention may be implemented. The computer system 1201 includes a bus 1202 or other communication mechanism for communicating information, and a processor 1203 coupled with the bus 1202 for processing the information. The computer system 1201 also includes a main memory 1204, such as a random access memory (RAM) or other dynamic storage device (e.g., dynamic RAM (DRAM), static RAM (SRAM), and synchronous DRAM (SDRAM)), coupled to the bus 1202 for storing information and instructions to be executed by processor 1203. In addition, the main memory 1204 may be used for storing temporary variables or other intermediate information during the execution of instructions by the processor 1203. The computer system 1201 further includes a read only memory (ROM) 1205 or other static storage device (e.g., programmable ROM (PROM), erasable PROM (EPROM), and electrically erasable PROM (EEPROM)) coupled to the bus 1202 for storing static information and instructions for the processor 1203.

The computer system 1201 also includes a disk controller 1206 coupled to the bus 1202 to control one or more storage devices for storing information and instructions, such as a magnetic hard disk 1207, and a removable media drive 1208 (e.g., floppy disk drive, read-only compact disc drive, read/write compact disc drive, compact disc jukebox, tape drive, and removable magneto-optical drive). The storage devices may be added to the computer system 1201 using an appropriate device interface (e.g., small computer system interface (SCSI), integrated device electronics (IDE), enhanced-IDE (E-IDE), direct memory access (DMA), or ultra-DMA).

The computer system 1201 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system 1201 may also include a display controller 1209 coupled to the bus 1202 to control a display 1210, such as a cathode ray tube (CRT), for displaying information to a computer user. The computer system includes input devices, such as a keyboard 1211 and a pointing device 1212, for interacting with a computer user and providing information to the processor 1203. The pointing device 1212, for example, may be a mouse, a trackball, or a pointing stick for communicating direction information and command selections to the processor 1203 and for controlling cursor movement on the display 1210. In addition, a printer may provide printed listings of data stored and/or generated by the computer system 1201.

The computer system 1201 performs a portion or all of the processing steps of the invention in response to the processor 1203 executing one or more sequences of one or more instructions contained in a memory, such as the main memory 1204. Such instructions may be read into the main memory 1204 from another computer readable medium, such as a hard disk 1207 or a removable media drive 1208. One or more processors in a multi-processing arrangement may also be employed to execute the sequences of instructions contained in main memory 1204. In alternative embodiments, hard-wired circuitry may be used in place of or in combination with software instructions. Thus, embodiments are not limited to any specific combination of hardware circuitry and software.

As stated above, the computer system 1201 includes at least one computer readable medium or memory for holding instructions programmed according to the teachings of the invention and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes, a carrier wave (described below), or any other medium from which a computer can read.

Stored on any one or on a combination of computer readable media, the present invention includes software for controlling the computer system 1201, for driving a device or devices for implementing the invention, and for enabling the computer system 1201 to interact with a human user (e.g., print production personnel). Such software may include, but is not limited to, device drivers, operating systems, development tools, and applications software. Such computer readable media further includes the computer program product of the present invention for performing all or a portion (if processing is distributed) of the processing performed in implementing the invention.

The computer code devices of the present invention may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

A computer readable medium providing instructions to a processor 1203 may take many forms, including but not limited to, non-volatile media, volatile media, and transmission media. Non-volatile media includes, for example, optical, magnetic disks, and magneto-optical disks, such as the hard disk 1207 or the removable media drive 1208. Volatile media includes dynamic memory, such as the main memory 1204. Transmission media includes coaxial cables, copper wire and fiber optics, including the wires that make up the bus 1202. Transmission media also may also take the form of acoustic or light waves, such as those generated during radio wave and infrared data communications.

Various forms of computer readable media may be involved in carrying out one or more sequences of one or more instructions to processor 1203 for execution. For example, the instructions may initially be carried on a magnetic disk of a remote computer. The remote computer can load the instructions for implementing all or a portion of the present invention remotely into a dynamic memory and send the instructions over a telephone line using a modem. A modem local to the computer system 1201 may receive the data on the telephone line and use an infrared transmitter to convert the data to an infrared signal. An infrared detector coupled to the bus 1202 can receive the data carried in the infrared signal and place the data on the bus 1202. The bus 1202 carries the data to the main memory 1204, from which the processor 1203 retrieves and executes the instructions. The instructions received by the main memory 1204 may optionally be stored on storage device 1207 or 1208 either before or after execution by processor 1203.

The computer system 1201 also includes a communication interface 1213 coupled to the bus 1202. The communication interface 1213 provides a two-way data communication coupling to a network link 1214 that is connected to, for example, a local area network (LAN) 1215, or to another communications network 1216 such as the Internet. For example, the communication interface 1213 may be a network interface card to attach to any packet switched LAN. As another example, the communication interface 1213 may be an asymmetrical digital subscriber line (ADSL) card, an integrated services digital network (ISDN) card or a modem to provide a data communication connection to a corresponding type of communications line. Wireless links may also be implemented. In any such implementation, the communication interface 1213 sends and receives electrical, electromagnetic or optical signals that carry digital data streams representing various types of information.

The network link 1214 typically provides data communication through one or more networks to other data devices. For example, the network link 1214 may provide a connection to another computer through a local network 1215 (e.g., a LAN) or through equipment operated by a service provider, which provides communication services through a communications network 1216. The local network 1214 and the communications network 1216 use, for example, electrical, electromagnetic, or optical signals that carry digital data streams, and the associated physical layer (e.g., CAT 5 cable, coaxial cable, optical fiber, etc). The signals through the various networks and the signals on the network link 1214 and through the communication interface 1213, which carry the digital data to and from the computer system 1201 maybe implemented in baseband signals, or carrier wave based signals. The baseband signals convey the digital data as unmodulated electrical pulses that are descriptive of a stream of digital data bits, where the term “bits” is to be construed broadly to mean symbol, where each symbol conveys at least one or more information bits. The digital data may also be used to modulate a carrier wave, such as with amplitude, phase and/or frequency shift keyed signals that are propagated over a conductive media, or transmitted as electromagnetic waves through a propagation medium. Thus, the digital data may be sent as unmodulated baseband data through a “wired” communication channel and/or sent within a predetermined frequency band, different than baseband, by modulating a carrier wave. The computer system 1201 can transmit and receive data, including program code, through the network(s) 1215 and 1216, the network link 1214 and the communication interface 1213. Moreover, the network link 1214 may provide a connection through a LAN 1215 to a mobile device 1217 such as a personal digital assistant (PDA) laptop computer, or cellular telephone.

The Securities Act is incorporated herein by reference in its entirety and as amended, expanded and codified at 15 U.S.C. including all relevant schedules and appendices. Likewise incorporated by reference herein are the Securities Exchange Act of 1934, the Trust Indenture Act of 1939, the Investment Company Act of 1940, the Investment Advisors Act of 1940, the Sarbanes Oxley Act of 2002, and the Securities and Exchange Commission Rules and Regulations including parts 200-301 as amended, expanded, and inclusive of all appendices and schedules.

One example of a continuous offering is the continuous offering described in the Form S-3 for Delta Airlines, Inc. filed with the SEC on Dec. 17, 2008. The Delta Airlines Inc. Form S-3 filed with the SEC on Dec. 17, 2008 is incorporated herein by reference in its entirety. In this continuous offering the issuer, Delta Airlines, carried out a continuous offering under a distribution agreement with Citigroup Global Markets Inc. who acted as a sales agent for the sale of the shares into the NYSE. The sales agent for this continuous offering obtained a commission equal to 2% of the sales price per share of shares sold in the continuous offering. Any of the aspects of the Delta airlines continuous offering may be incorporated in the method, system, financial product and/or computer program product described herein.

The continuous offering program agreement of Rodman & Renshaw LLC (the Rodman Continuous Offering) is incorporated herein by reference in its entirety. Under the details of the Rodman Continuous Offering an agent or intermediary may collect a fee for carrying out sales and marketing of securities.

Further embodiments and advantages of aspects that maybe included in the invention are described in the Rodman & Renshaw's “At-The-Market Offering Program” circular, incorporated herein by reference in its entirety.

U.S. patent application 61/156,354 and U.S. Ser. No. 12/713,921 are incorporated herein in their entireties including any attachments, appendixes or materials incorporated by reference.

U.S. patent application Ser. No. ______ titled “Method, System, Computer Program Product and Marketplace for Private and Public Investment” filed on Aug. 23, 2010 and naming Michael Vasinkevich as an inventor is incorporated herein by reference in its entirety.

Obviously, numerous modifications and variations of the present invention are possible in light of the above teachings. It is therefore to be understood that within the scope of the appended claims, the invention may be practiced otherwise than as specifically described herein.

1: A method for selling a primary security on a public exchange on which a corresponding secondary security is concurrently offered for sale at a secondary market price, comprising:
determining the secondary market price of the secondary security on the public exchange;
offering a first amount of the primary security for sale on the public exchange at a primary market price that is the same or substantially the same as the secondary market price;
selling the primary security to a buyer at the primary market price;
wherein the primary security is offered for sale and sold by a seller and/or on behalf of the seller, and the seller is the issuer of the primary security;
wherein the primary security is a registered shelf offering; and
wherein during the selling, the primary security is indistinguishable from the secondary security to the buyer.

2: The method of claim 1, wherein the public exchange is a U.S. national exchange.

3: The method of claim 1, wherein the primary market price is the price at which the secondary security was last sold.

4: The method of claim 1, wherin the primary security is at least one selected from the group consisting of common stock of the primary issuer, preferred stock of the primary issuer, an option to buy common or preferred stock of the primary issuer, and warrants for the purchase of common or preferred stock of the primary issuer.

5: The method of claim 1, wherein during the offering the primary issuer directly communicates a sell order to the market or communicates a sell order to the public exchange through an intermediary.

6: The method of claim 5, wherein the mediator is a broker or market maker.

7: The method of claim 1, wherein during the selling the seller agrees to transfer the primary securities to the buyer.

8: The method of claim 1, wherein the primary issuer sells the primary issue without an underwriter.

9: The method of claim 1, wherein the primary securities are not underwritten.

10: A system for a primary issuer to issue and sell a primary security on a public exchange on which a corresponding secondary security is concurrently offered for sale to one or more buyers, comprising:
a communications network connecting a primary issuer of the primary security to a public exchange,
a primary issuer trading device connecting the seller to the public market by the communications network,
a buyer trading device connecting the buyer to the public market by the communications network,
wherein the primary security is a registered shelf offering;
wherein the primary issuer issues and sells the primary security into the public exchange over the communications network such that the primary security and the secondary security are concurrently offered for sale at the same price on the public exchange and are indistinguishable from one another; and
the buyer buys the primary security and, optionally, the secondary security.

11: The system of claim 10, wherein the public exchange is a U.S. national exchange.

12: The system of claim 10, wherein the communications network is the Internet.

13: The system of claim 10, wherein the primary issuer trading device is a computer terminal with a processor and memory.
